(19) United States
(12) Patent Application Publication
(10) Pub. No.: US 2026/0100068 A1
(43) Pub. Date: Apr. 9, 2026

(54) TABULAR DATA EXTRACTION AND RETRIEVAL FROM ELECTRONIC DOCUMENTS

(71) Applicant: Genpact USA, Inc., New York, NY (US)

(72) Inventors: Nirdosh Rawal, Panipat (IN); Meenakshi Sundaram Murugeshan, Bangalore (IN); Prakash Selvakumar, Bangalore (IN); Sreekanth Menon, Bangalore (IN)

(21) Appl. No.: 18/905,744

(22) Filed: Oct. 3, 2024

(51) Int. Cl. G06V 30/41

(52) U.S. Cl. CPC G06V 30/41

(57) ABSTRACT

A system for extracting tabular data from an electronic document including an extraction engine that extracts tabular data from the electronic document using a plurality of data extraction services to provide a plurality of individual datasets, a population engine configured to generate a dataset population by arranging each individual dataset into a key-value format, and a selection engine configured to derive a final dataset based on the dataset population using a genetic algorithm.

### TECHNICAL FIELD

The following disclosure is directed to systems and methods for extracting tabular data from electronic documents and, more specifically, to the use of genetic algorithms to extract tabular data.

### BACKGROUND

Tabular data extraction from electronic documents (e.g., PDFs) can be challenging due to varying table structures. For example, merged cells, different row/column spans, and nested structures may introduce errors in data extracted from tables. Vision Language Models (VLMs) and other types of extraction libraries struggle to accurately capture and represent complex structures. Most services for table extraction (e.g., cloud services) have limited capabilities, and customizing or finetuning such services for specific use cases is difficult. Such services typically output the textual content of the electronic document as raw text, without maintaining the original structure or layout from the electronic document. The raw text output does not preserve the original tabular structure, making it challenging to accurately identify and extract tables.

### SUMMARY

Further aspects and advantages of the invention will become apparent from the following drawings, detailed description, and claims, all of which illustrate the principles of the invention, by way of example only.

At least one aspect of the present disclosure is directed to a system for extracting tabular data from an electronic document. The system includes an extraction engine configured to receive an electronic document and extract tabular data from the electronic document. The extraction engine extracts the tabular data using a plurality of data extraction services to provide a plurality of individual datasets. A population engine is configured to generate a dataset population by arranging each individual dataset into a key-value format. A selection engine is configured to derive a final dataset based on the dataset population using a genetic algorithm.

In some embodiments, the selection engine, when performing the genetic algorithm, performs steps that include selecting a first group of individual datasets from the dataset population, selecting a second group of individual datasets from the dataset population, selecting a first parent dataset from the first group of individual datasets, selecting a second parent dataset from the second group of individual datasets, combining the first and second parent datasets to produce a child dataset, selectively mutating the child dataset, and replacing an individual dataset in the dataset population with the child dataset.

In some embodiments, the selection engine randomly selects the first and second groups of individual datasets from the dataset population. In some embodiments, selectively mutating the child dataset includes, for each key of the child dataset, generating a random mutation score, determining whether to perform a mutation based on the mutation score and a mutation threshold, and in response to a determination that a mutation should be performed, randomly selecting at least one replacement value for the child dataset from values corresponding to the same key in the dataset population. In some embodiments, the population engine is configured to generate a plurality of desired keys based on the dataset population. In some embodiments, combining the first and second parent datasets to produce the child dataset includes, for each desired key of the plurality of desired keys, determining whether the first parent dataset includes the desired key, determining whether the second parent dataset includes the desired key, in response to a determination that only one of the first and second parent datasets includes the desired key, assigning a corresponding value from the parent dataset having the desired key to a corresponding key in the child dataset, and in response to a determination that both the first and second parent datasets include the desired key, selecting a corresponding value from the first parent dataset or the second parent dataset based on a predetermined metric, wherein the selected value is assigned to a corresponding key in the child dataset.

In some embodiments, the selection engine uses a fitness function to assign a fitness score to each individual dataset in the dataset population, the fitness score representing a number of desired keys that are present in the individual dataset. In some embodiments, the first parent dataset selected by the selection engine has a highest fitness score amongst the first group of individual datasets and the second parent dataset selected by the selection engine has a highest fitness score amongst the second group of individual datasets. In some embodiments, the individual dataset replaced by the selection engine with the child dataset has a lowest fitness score amongst the dataset population. In some embodiments, the selection engine is configured to repeat the genetic algorithm until a predetermined number of iterations is reached. In some embodiments, the selection engine is configured to select the final dataset from the dataset population once the predetermined number of iterations has been reached. In some embodiments, the final dataset selected by the selection engine has a highest fitness score amongst the dataset population.

Another aspect of the present disclosure is directed to a method for extracting tabular data from an electronic document. The method includes receiving an electronic document via an extraction engine. Tabular data is extracted from the electronic document via the extraction engine. The tabular data is extracted using a plurality of data extraction services to provide a plurality of individual datasets. A dataset population is generated, via a population engine, by arranging each individual dataset into a key-value format. A final dataset is derived, via a selection engine, based on the dataset population using a genetic algorithm.

In some embodiments, deriving the final dataset using the genetic algorithm includes selecting a first group of individual datasets from the dataset population, selecting a second group of individual datasets from the dataset population, selecting a first parent dataset from the first group of individual datasets, selecting a second parent dataset from the second group of individual datasets, combining the first and second parent datasets to produce a child dataset, selectively mutating the child dataset, and replacing an individual dataset in the dataset population with the child dataset.

In some embodiments, selecting the first and second groups from the dataset population includes randomly selecting the first and second groups of individual datasets from the dataset population. In some embodiments, selectively mutating the child dataset includes, for each key of the child dataset, generating a random mutation score, determining whether to perform a mutation based on the mutation score and a mutation threshold, and in response to a determination that a mutation should be performed, randomly selecting at least one replacement value for the child dataset from values corresponding to the same key in the dataset population.

In some embodiments, the method includes generating, via the population engine, a plurality of desired keys based on the dataset population. In some embodiments, combining the first and second parent datasets to produce the child dataset includes, for each desired key of the plurality of desired keys, determining whether the first parent dataset includes the desired key, determining whether the second parent dataset includes the desired key, in response to a determination that only one of the first and second parent datasets includes the desired key, assigning a corresponding value from the parent dataset having the desired key to a corresponding key in the child dataset, and in response to a determination that both the first and second parent datasets include the desired key, selecting a corresponding value from the first parent dataset or the second parent dataset based on a predetermined metric, wherein the selected value is assigned to a corresponding key in the child dataset.

In some embodiments, the method includes assigning, via the selection engine, a fitness score to each individual dataset in the dataset population, the fitness score representing a number of desired keys that are present in the individual dataset. In some embodiments, selecting the first parent dataset from the first group of individual datasets comprises selecting the individual dataset having the highest fitness score amongst the first group of individual datasets, and selecting the second parent dataset from the second group of individual datasets comprises selecting the individual dataset having the highest fitness score amongst the second group of individual datasets. In some embodiments, replacing an individual dataset in the dataset population with the child dataset comprises replacing the individual dataset having the lowest fitness score amongst the dataset population with the child dataset. In some embodiments, deriving the final dataset using the genetic algorithm comprises repeating the genetic algorithm until a predetermined number of iterations is reached. In some embodiments, the final dataset is selected from the dataset population once the predetermined number of iterations has been reached. In some embodiments, selecting the final dataset comprises selecting the individual dataset having the highest fitness score amongst the dataset population.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 illustrates a block diagram of a data extraction system in accordance with aspects described herein;

FIG. 2 illustrates a flow diagram corresponding to operation of the data extraction system of FIG. 1 in accordance with aspects described herein;

FIG. 3A illustrates an example data table in accordance with aspects described herein;

FIG. 3B illustrates example data extracted by an extraction engine from the data table of FIG. 3A in accordance with aspects described herein;

FIG. 4 illustrates example datasets extracted by an extraction engine in accordance with aspects described herein;

FIG. 5 illustrates an example dataset population based on the datasets of FIG. 4 in accordance with aspects described herein;

FIG. 6A illustrates a flow diagram of a selection process of a genetic algorithm in accordance with aspects described herein;

FIG. 6B illustrates an example of the selection process of FIG. 6A in accordance with aspects described herein;

FIG. 7 illustrates a flow diagram of a cross-over process of a genetic algorithm in accordance with aspects described herein;

FIG. 8 illustrates a flow diagram of a mutation process of a genetic algorithm in accordance with aspects described herein; and

FIG. 9 illustrates an example computing device.

### DETAILED DESCRIPTION

Disclosed herein are exemplary embodiments of systems and methods for extracting tabular data from electronic documents.

As described above, tabular data extraction from electronic documents (e.g., PDFs) can be challenging and error-prone due to varying table structures. VLMs and other types of extraction libraries struggle to accurately capture and represent complex table structures. Likewise, services that provide table extraction functionality often have limited capabilities and typically output the textual content of the electronic document as raw text, without maintaining the original structure or layout from the electronic document.

As such, improved systems and methods for extracting tabular data from electronic documents are provided herein. The system proficiently extracts tables from a wide range of formats, such as invoices, scanned tables, and other document types. The system efficiently handles tables that are split across multiple pages in documents, ensuring seamless data processing and organization. In some embodiments, the system is configured to perform table extraction utilizing a Genetic Algorithm (GA) process. The GA process initiates with a population of individuals, where each individual represents a potential solution in the form of key-value pair dictionaries. In some embodiments, the use of key-value pairs provides for a dependable and efficient data processing experience. Table extraction using key-value pairs (or sets) can simplify data organization, which benefits Retrieval Augmented Generation (RAG) applications by enabling efficient data retrieval. In some examples, this leads to improved search results and faster response times, ensuring a more effective user experience.

In some embodiments, the system performs a series of steps including initialization, fitness evaluation, selection, cross-over, and mutation. In some embodiments, by evaluating the fitness of each individual based on desired keys, selecting the fittest individuals for reproduction, and introducing variation via crossover and mutation, the GA process efficiently extracts high-quality data from tables of electronic documents. In some embodiments, the GA process not only enhances the accuracy of table extraction but also preserves diversity in the population, leading to robust and comprehensive extraction outcomes.

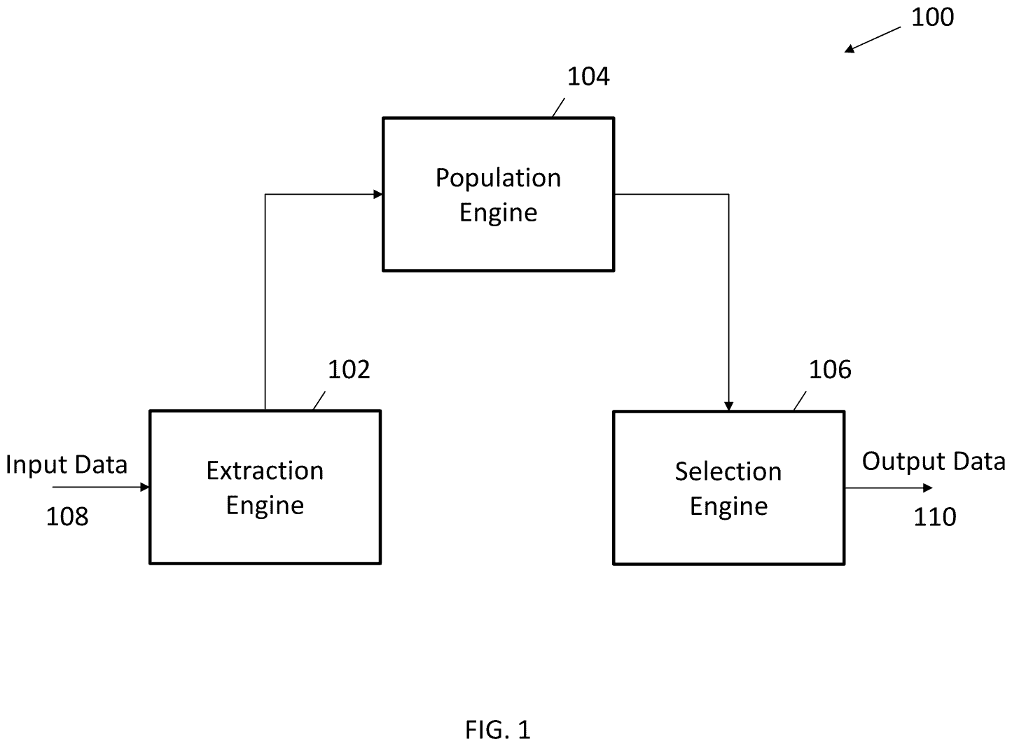

FIG. 1 illustrates a block diagram of a data extraction system 100 in accordance with aspects described herein. As shown, the system 100 includes an extraction engine 102, a population engine 104, and a selection engine 106. In some examples, the engines of the system 100 are implemented by one or more application servers. Each application server comprises software components and databases that can be deployed at one or more data centers in one or more geographic locations, for example. The software components can comprise subcomponents that can execute on the same or on a different individual data processing apparatus. The databases can reside in one or more physical storage systems. Example features of the software components and data processing apparatus will be further described below.

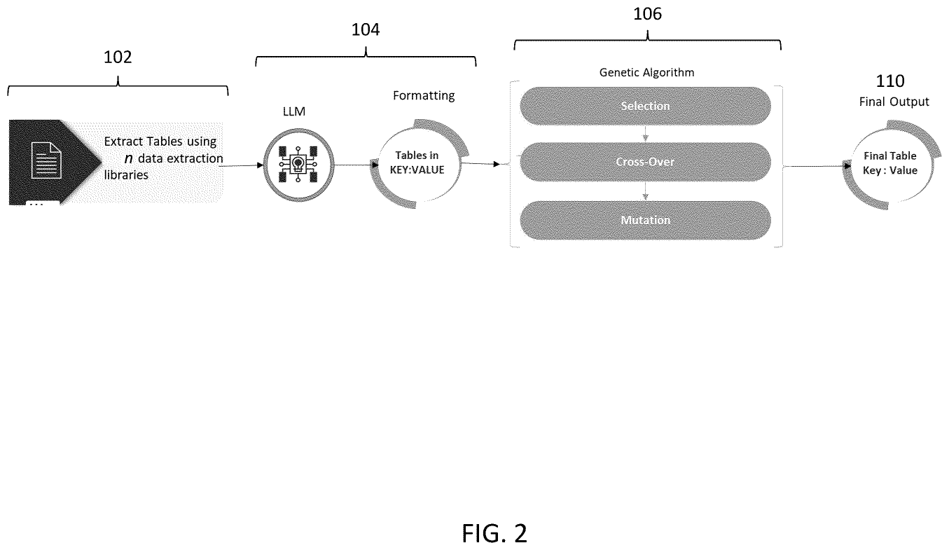

FIG. 2 illustrates a flow diagram corresponding to operation of the data extraction system 100 in accordance with aspects described herein. In some examples, the extraction engine 102 is configured to receive an electronic document (e.g., input data 108 of FIG. 1). In some examples, the electronic document is a PDF (e.g., a .pdf file). In other examples, the electronic document may be, for example, a text document (e.g., a .txt file), a rich text format file (e.g., an .rtf file), a word processing document (e.g., a .doc or .docx file), PDF (e.g., a .pdf file a custom document format, or another desired document format. In such examples, once the electronic document is received, a conversion layer of the extraction engine 102 may first convert the electronic document into a unified format, such as a PDF, to streamline the subsequent processing steps. The extraction engine 102 extracts data from one or more data tables in the electronic document. In some examples, the extraction engine 102 extracts data from all tables in the electronic document. In some examples, the extraction engine 102 extracts data only from tables that it is instructed to extract from. In cases where data is being extracted from multiple data tables, the system 100 may process each table separately to prevent cross-contamination of the data.

The extraction engine 102 is configured to extract data using a plurality of data extraction services to provide a plurality of individual datasets. In some examples, the extraction engine 102 includes, or is configured to access, n extraction services, where n≥2. The use of multiple data extraction services (or configurations of data extraction services) enables the extraction engine 102 to provide different individual datasets. In some examples, the differences across the individual datasets correspond to the strengths (and weaknesses) of each data extraction service. The data extraction services may include, for example, Optical Character Recognition (OCR) services or libraries, dedicated data extraction services or libraries (e.g., Tabula or PDFTables), data integration services or libraries (e.g., Alteryx), Extract-Transform-Load (ETL) services or libraries (e.g., Talend), machine learning and AI-based services (e.g., Amazon Textract or Google Cloud Vision OCR), web-based tools and APIs (e.g., Docparser or PDF.co), custom scripting and programming libraries in Python (e.g., PyPDF2, pdfplumber, camelot, or pandas) and R (e.g., pdftools or tabulizer), or any combination thereof.

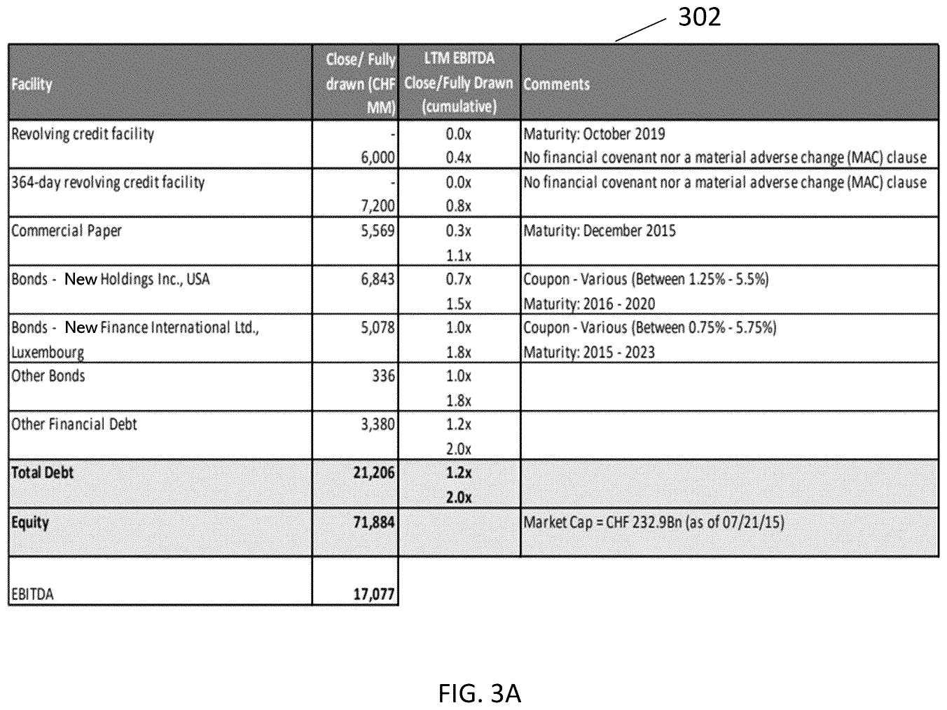

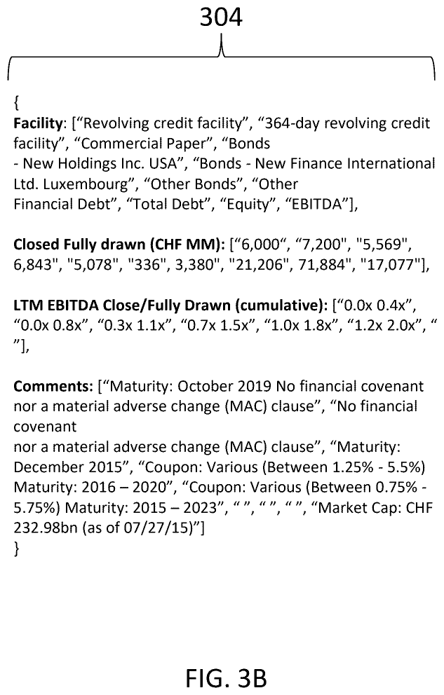

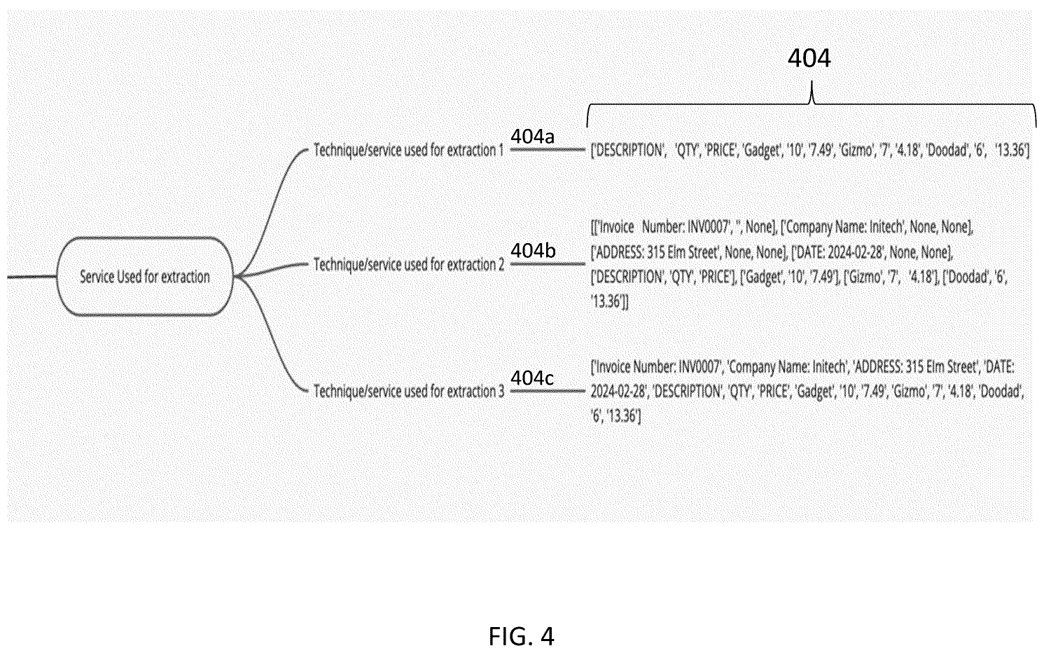

FIG. 3A illustrates an example data table 302 and FIG. 3B illustrates the corresponding data 304 extracted by a single extraction service of the extraction engine 102. The extracted data 304 represents an “individual” or “individual dataset.” Likewise, FIG. 4 illustrates an example of individual datasets 404 extracted by the n extraction services of the extraction engine 102. As shown, the individual datasets 404a, 404b, and 404c include differences corresponding to the respective extraction services used. While n=3 in the illustrated example, it should be appreciated that n may be a different value (e.g., 2, 5, 10, etc.). In some examples, the value of n is determined based on the type of electronic document (or table) from which data is being extracted. For example, the extraction engine 102 may adjust the value of n based on predetermined configurations for specific types of documents (e.g., invoice, academic paper, PDF file, txt file, etc.). Likewise, the extraction engine 102 may adjust the value of n based on predetermined configurations for specific table parameters (e.g., size, font, location in document, etc.). In some examples, the value of n may be selected or adjusted by a user via the UI of the system 100.

Similarly, the types of extraction services used may be fixed or variable. In some examples, the extraction engine 102 is configured to use a predetermined set of n extraction services. In some examples, the extraction engine 102 may select different extraction services based on the type of electronic document (or table) that data is being extracted from. For example, the extraction engine 102 may select specific extraction services based on predetermined configurations for specific types of documents or table parameters. In other words, the n extraction services used for a first type of document (e.g., invoice, PDF file, etc.) may be different than the n extraction services used for a second type of document (e.g., academic paper, txt file, etc.). Likewise, the n extraction services used for a table having a first parameter (e.g., size=large) may be different than the n extraction services used for a table having a second parameter (e.g., size=small). In some examples, the types of extraction services used may be selected or adjusted by the user via the UI of the system 100. In some examples, the type of extraction services used may be selected or adjusted based on the services that the user has access to (e.g., has a license to use).

While the example of FIG. 4 uses n extraction services to produce n individual datasets, it should be appreciated that the extraction engine 102 may be configured differently. In some examples, the extraction engine 102 is configured to use n extraction services to produce m individual datasets, where m≠n. In such examples, a single extraction service may be used to produce two or more of the m individual datasets. In some examples, a parameter or setting of the extraction service is adjusted to produce different datasets. For example, where m=3 and n=2, a first individual dataset may correspond to Extraction Service A configured with parameter X, a second individual dataset may correspond to Extraction Service A configured with parameter Z, and a third individual dataset may correspond to Extraction Service B. As such, three individual datasets are produced using two extraction services. In some examples, different configurations of a single extraction service may be used to produce each individual dataset (e.g., Extraction Service A configured with parameters, X, Y, and Z). Likewise, the extraction engine 102 may be configured such that the number of extraction services outnumbers the number of individual datasets produce (i.e., n>m). For example, the outputs of two or more extraction services may be combined or merged to produce a single individual dataset. In some examples, m individual datasets are selected (e.g., randomly) from a pool of k datasets produced by the n extraction services, where n≥k>m. In some examples, the value of m is scaled based on the complexity of the input data 108. For example, the value of m may be increased with complexity.

Returning to FIG. 2, the population engine 104 is configured to generate a dataset population by arranging each individual dataset into a key-value format. The key-value format corresponds to key-value pairs (or sets). A key-value pair/set consists of two or more related data elements: a key, which is a constant that defines the value set (e.g., gender, color, price), and at least one value, which is a variable that belongs to the set (e.g., male/female, green, 100). In some examples, the population engine 104 includes an artificial intelligence (AI) or machine learning (ML) model that is trained to arrange the data of the individual datasets (e.g., datasets 404 of FIG. 4) into the key-value format. In some examples, the population engine 104 uses a Large Language Model (LLM) to convert or arrange the individual datasets into the key-value format. In some examples, the population engine 104 (or the LLM) includes one or more Generative Pre-trained Transformer (GPT) models or Natural Language Processing (NLP) models. In some examples, the population engine 104 is configured to issue one or more prompts to the LLM that instruct the LLM to perform the key-value conversion or arrangement. The prompt(s) may include preferences or restrictions to guide the performance of the LLM. For example, the LLM may be prompted with a preferred format (e.g., dictionary) for the key-value sets. Likewise, the LLM may be prompted to exclude duplicate values, to include column names in the key-value format, and to prevent data loss.

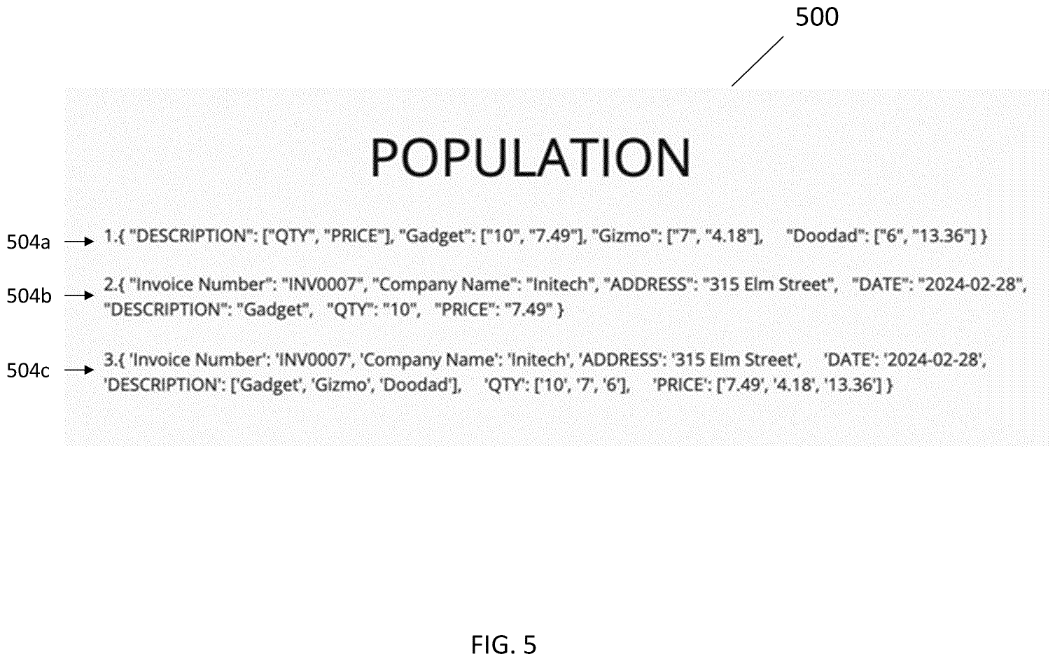

FIG. 5 illustrates an example dataset population (or population) 500 based on the individual datasets 404 of FIG. 4. As shown, the individual datasets 504 of the population 500 correspond to the individual datasets 404 arranged in the key-value format. For example, the first individual dataset 504a corresponds to the individual dataset 404a, the second individual dataset 504b corresponds to the individual dataset 404b, and the third individual dataset 504c corresponds to the individual dataset 404c. Each individual dataset 504 represents a potential solution (i.e., a potential option for a final dataset 110). It should be appreciated that the initial individual datasets 504 of the population 500 may disagree on the arrangement of keys and values. For example, the first individual dataset 504a includes a “DESCRIPTION” key having values of “QTY” and “PRICE” and a “Gadget” key having values of “10” and “7.49,” the second individual dataset 504b includes a “DESCRIPTION” key having a value of “Gadget,” a “QTY” key having a value of “10,” and a “PRICE” key having a value of “7.49,” and the third individual dataset 504c includes a “DESCRIPTION” key having values of “Gadget,” “Gizmo,” and “Doodad,” a “PRICE” key having values of “7.49,” “4.18,” and “13.36,” and a “QTY” key having values of “10,” “7,” and “6.”

In some examples, the population engine 104 is configured to generate (or identify) a plurality of desired keys for the dataset population 500. The plurality of desired keys represent the keys that are to be included in the final dataset 110 (i.e., the output of the system 100). An example of desired keys for the dataset population 500 may be “Invoice Number,” “Company Name,” “ADDRESS,” “DATE,” “DESCRIPTION,” QTY,” and “PRICE.” In some examples, the population engine 104 uses the LLM (or another AI/ML model) to generate the plurality of desired keys from the dataset population 500. For example, the population engine 104 may provide one or more prompts that instruct the LLM to generate the plurality of desired keys based on the dataset population 500. In some examples, the prompts instruct the LLM to identify desired keys from the pool of keys in the dataset population 500 based on specific criteria. For example, the prompts may instruct the LLM to identify unique keys in the dataset population 500 that appear in two or more individual members 504. In some examples, the prompts may instruct the LLM to identify the unique keys that appear in at least three members 504, and so on.

Returning to FIG. 2, the selection engine 106 is configured to provide the output dataset 110 based on the dataset population 500 using a GA. The GA includes (i) a selection process, (ii) a cross-over process, and (iii) a mutation process. In some examples, the selection engine 106 is configured to iteratively perform the processes of the GA p times. After the p^{th} iteration of the GA processes, the selection engine 106 provides the final dataset (or table). The value of p may be fixed or variable. For example, the value of p may be fixed (e.g., 10, 100, 1000, etc.) such that all input data 108 is processed the same. In some examples, the value of p is scaled based on one or more characteristics of the input data 108. For example, the value of p may be scaled based the size of the input data 108, the number of rows or columns in the data table, or the number of desired keys in the plurality of desired keys. In some examples, the convergence rate of the GA corresponds to the complexity or size of the input data 108. As such, increasing the value of p for larger or more complex data tables may improve the accuracy of the GA and the system 100.

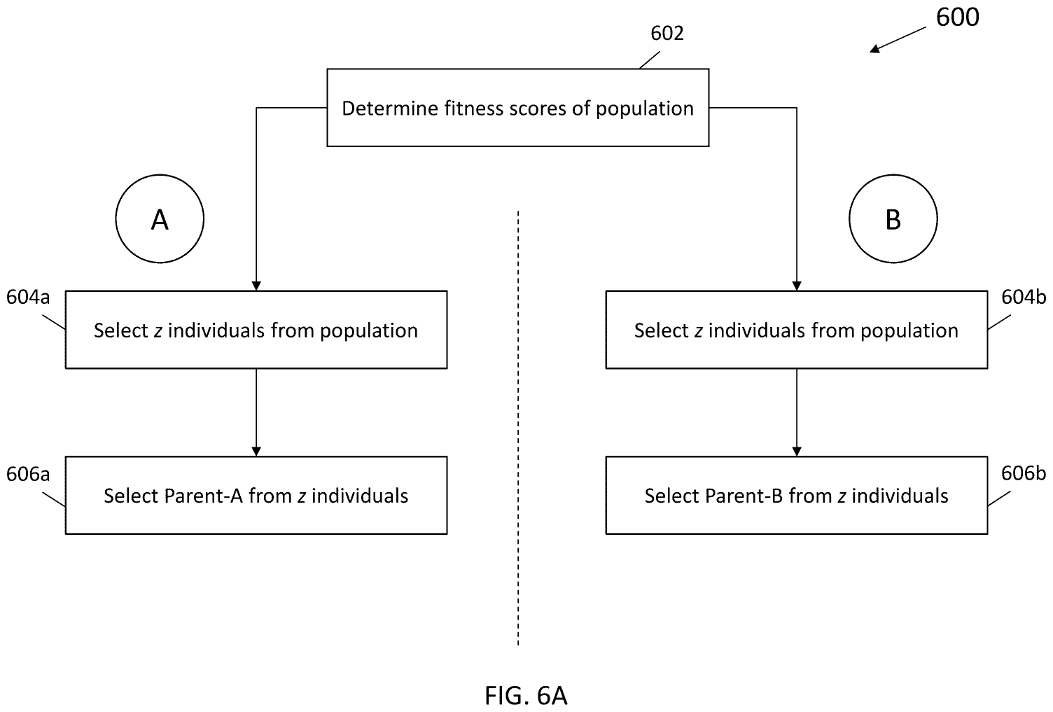

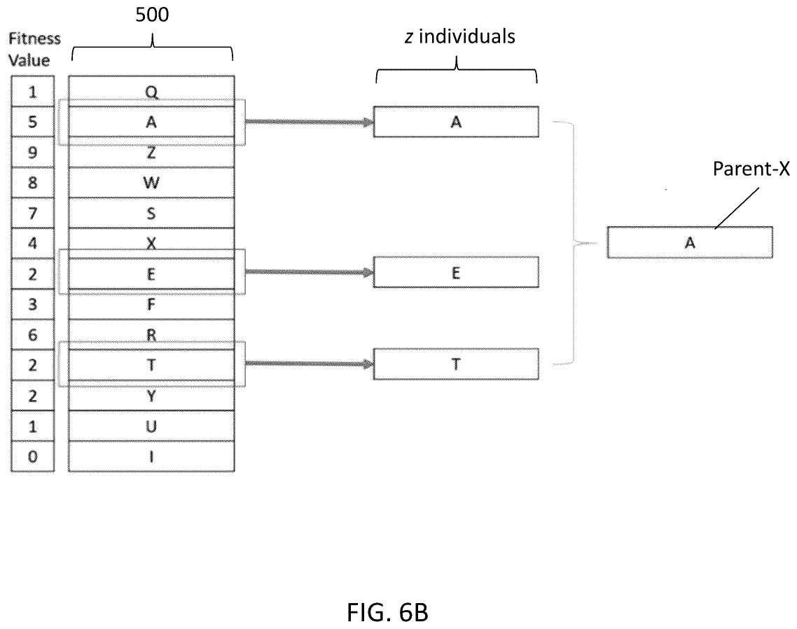

FIGS. 6A and 6B are diagrams illustrating the selection process 600 of the GA. At step 602, the selection engine uses a fitness function to assign a fitness score to each individual dataset 504 in the dataset population 500. In some examples, the fitness function is configured to count the number of desired keys present in each individual dataset. The fitness function may be constructed (or trained) based on the desired keys generated by the population engine 104. In some examples, the fitness function is a script that searches for the desired keys in each individual dataset 504. In some examples, the fitness score represents the number of desired keys that are present in the individual dataset 504. For example, if an individual dataset 504 includes 3 out of 4 desired keys, the individual score may be assigned a fitness score of 3. It should be appreciated that the fitness score may be represented in a different format (e.g., 75%).

Once the fitness scores have been calculated, the remaining steps 604 and 606 of the selection process 600 may be performed in separate parallel threads (e.g., A and B in FIG. 6A). At step 604, the selection engine 106 selects z individual datasets 504 from the dataset population 500. The number of selected individual datasets 504 (i.e., z) corresponds to a subset or a portion of the dataset population 500. In some examples, z=q−1, where q is the number of individuals in the dataset population. In other examples, the value of z is a different number (e.g., a fixed number, a percentage, or a user-specified number). The selection engine 106 is configured to randomly select the z individual datasets 504. In some examples, the selection engine 106 uses a tournament function to perform the random selection. FIG. 6B illustrates an example selection of z individual datasets 504 from the dataset population 500, where z=3. It should be appreciated that the selection engine 106 selects a first group of z individual datasets 504 for thread A (step 604a) and a second group of z individual datasets 504 for thread B (step 604b). The first and second groups may include one or more of the same individual datasets 504.

At step 606, the selection engine 106 is configured to select a parent from the selected groups of z individual datasets 504. In other words, the selection engine 106 selects the Parent-A dataset for thread A from the first group of z individual datasets 504 (step 606a) and the Parent-B dataset for thread B from the second group of z individual datasets 504 (step 606b). In some examples, the parent dataset is selected from each group based on the fitness scores assigned in step 602. For example, the individual dataset 504 with the highest fitness score may be selected as the parent dataset for each group. As shown in FIG. 6B, individual dataset A has a fitness score (or value) of 5, individual dataset E has a fitness score of 2, and individual dataset T has a fitness score of 2. As such, individual dataset A is selected as the Parent-X dataset because it has the highest fitness score amongst the group of selected individual datasets. In the event of a tie, where two or more individual datasets share the same fitness score, one of tied datasets may be randomly selected as the parent dataset. In some examples, one of the tied datasets is selected as the parent dataset based on a metric associated with values of the dataset. For example, the average length of values corresponding to desired keys may be used to select the parent dataset from the tied datasets. Likewise, the sum of all value lengths corresponding to desired keys may be used to select the parent dataset from the tied datasets.

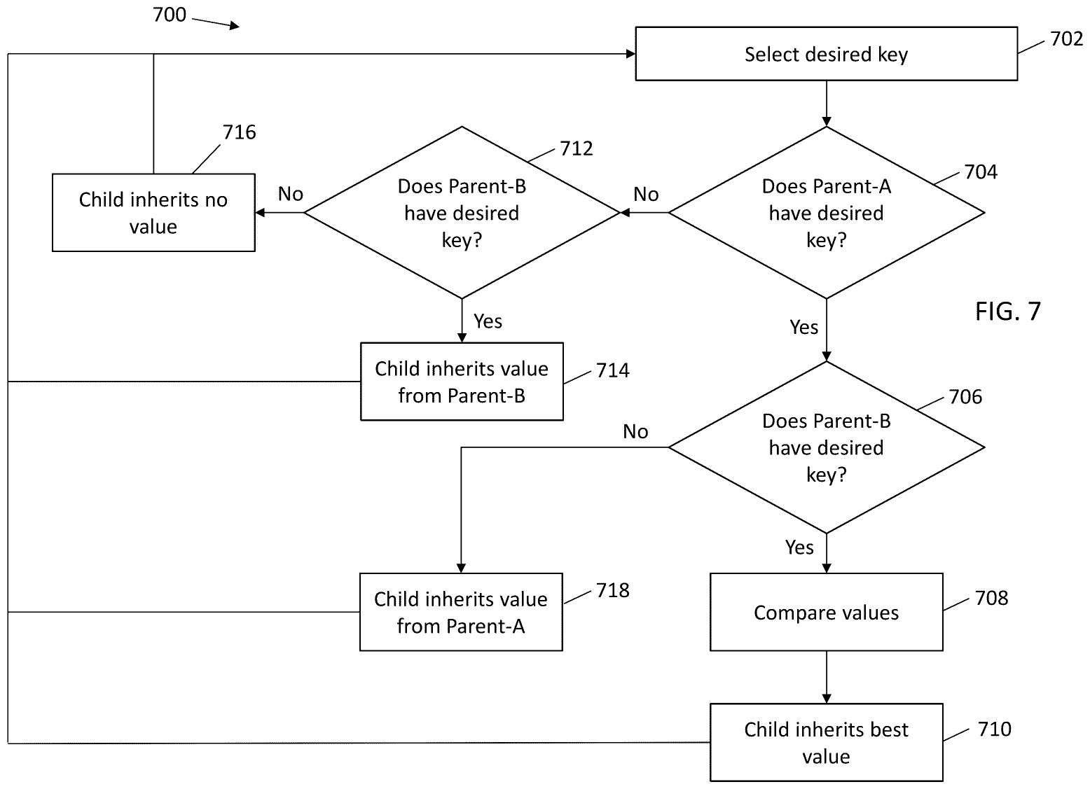

FIG. 7 is a diagram illustrating the cross-over process 700 of the GA. The cross-over process 700 follows the selection process 600 in the GA sequence. The cross-over process 700 is performed by the selection engine 106 to combine the Parent-A dataset with the Parent-B dataset to produce a child dataset. In some examples, the cross-over process 700 is performed on a key-by-key basis. In other words, each cycle through the cross-over process 700 corresponds to a desired key of the plurality of desired keys.

At step 702, the selection engine 106 selects a first desired key from the plurality of desired keys (e.g., “Invoice Number”). At step 704, the selection engine 106 determines whether the Parent-A dataset has the desired key. If so, the selection engine 106 moves on to step 706, where the selection engine 106 determines whether the Parent-B dataset has the desired key. If the Parent-B dataset does have the desired key, the values corresponding to the desired key from the Parent-A and Parent-B datasets are compared by the selection engine 106 at step 708. In some examples, the comparison corresponds to the length of the values. For example, the character length of the corresponding value for the Parent-A dataset may be compared to the character length of the corresponding value for the Parent-B dataset. In some examples, the value having the longest length is considered to be the “best” value. In some examples, the character length includes all values for the respective key-value pair. For example, if “DESCRIPTION” is the key and Parent A has the values {gadget, gizmo, doodad}, the corresponding character length for Parent A is 17 (or 19 if including separating commas). At step 710, the selection engine 106 selects the “best” value(s) for the child dataset from either the Parent-A dataset or the Parent-B dataset. The cross-over process 700 then returns to step 702, where the selection engine 106 selects the next desired key from the plurality of desired keys and repeats. The cross-over process 700 is repeated for each desired key in the plurality of desired keys.

Returning to step 704, in the event the Parent-A dataset does not have the desired key, the selection engine 106 determines whether the Parent-B dataset has the desired key. If so, at step 714, the selection engine 106 selects the value(s) for the child dataset from the Parent-B dataset. If neither the Parent-A dataset nor the Parent-B dataset have the desired key, then no value is selected for the particular desired key and the respective key-value pair will not be present in the child dataset (step 716). Likewise, back at step 706, if it is determined that the Parent-A dataset does have the desired key but that the Parent-B dataset does not have the desired key, the selection engine selects the value(s) for the child dataset from the Parent-A dataset (step 718).

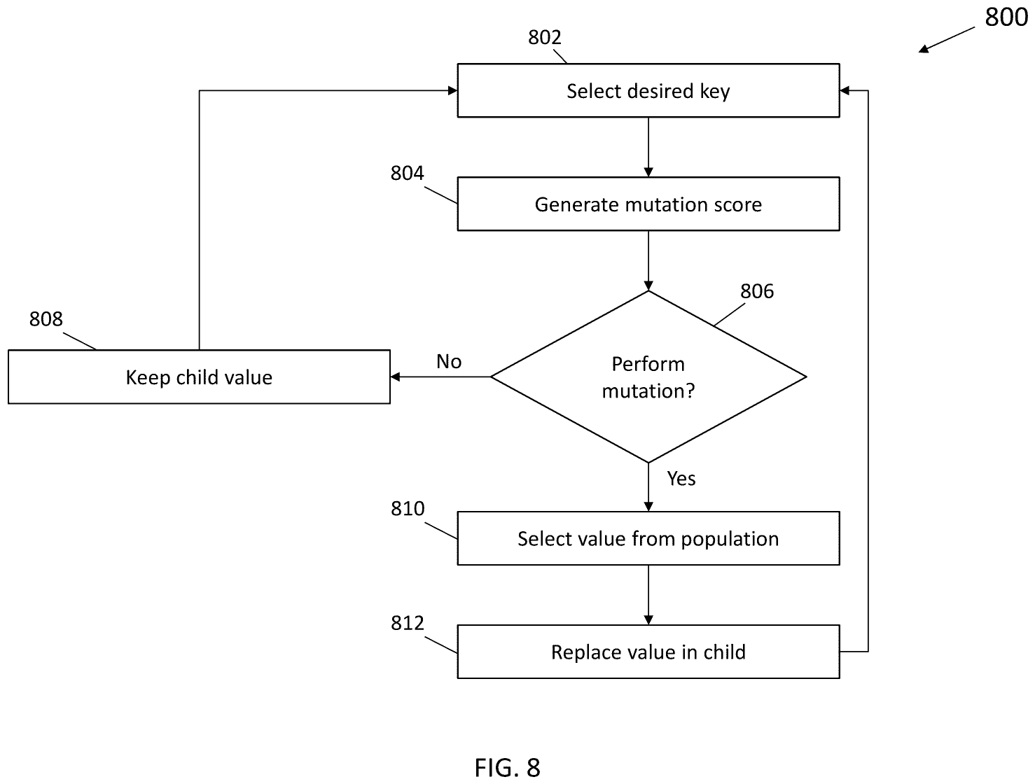

FIG. 8 is a diagram illustrating the mutation process 800 of the GA. The mutation process 800 follows the cross-over process 700 in the GA sequence. The mutation process 800 is performed by the selection engine 106 to selectively mutate the child dataset. In some examples, the mutation process 800 is performed on a key-by-key basis. In other words, each cycle through the mutation process 800 corresponds to a desired key of the plurality of desired keys.

At step 802, the selection engine 106 selects a first desired key from the plurality of desired keys (e.g., “Invoice Number”). At step 804, the selection engine 804 generates a mutation score for the desired key. In some examples, the mutation score is randomly generated. For example, a random number generator may be configured to generate a mutation score within a predetermined range (e.g., 0 to 10, 0 to 100, etc.). In some examples, the mutation score is randomly selected from a predetermined set of values.

At step 806, the selection engine 106 determines whether a mutation should be performed based on the mutation score. In some examples, the selection engine 106 compares the mutation score to a mutation threshold to determine whether a mutation should be performed. The mutation threshold is set within the same range that the mutation score is generated from (e.g., 0 to 100). The selection engine 106 may determine that a mutation should be performed if the mutation score is above or below the mutation threshold. For example, if the mutation threshold is set at 5, the selection engine may determine that a mutation should be performed if the mutation score is equal to or less than 5. Alternatively, if the mutation score is set at 95, the selection engine may determine that a mutation should be performed if the mutation score is equal to or greater than 95. In both cases, a mutation is expected to be performed 5 out of 100 times, or 5% of the time (i.e., the mutation rate). It should be appreciated that the threshold numbers described above are for exemplary purposes and are not intended to be limiting. In addition, it should be appreciated that steps 804 and 806 may be replaced with a probability generator. In such examples, the probability generator automatically determines whether a mutation should be performed based on a predetermined probability (e.g., 5% of the time).

At step 808, in response to a determination that no mutation is to be performed, the child dataset keeps the value(s) assigned to the desired key and the process 800 returns to step 802, where the selection engine 106 selects the next desired key from the plurality of desired keys. At step 810, in response to a determination that a mutation is to be performed, the selection engine 106 selects a replacement value (or values) from the dataset population 500. In some examples, the selection engine 106 randomly selects the replacement value(s). For example, the replacement value(s) may be randomly selected from the pool of values in the dataset population that correspond to the desired key, excluding the current value(s) assigned to the child dataset. In some examples, the selection engine 106 may select an individual dataset 504 from the dataset population 500 and the value(s) from the selected dataset 504 is used as the replacement value(s) for the child dataset. At step 812, the selection engine 106 replaces the value(s) in the child dataset with the replacement value(s) to produce a mutated child dataset. The process 800 then returns to step 802, where the selection engine 106 selects the next desired key from the plurality of desired keys. The mutation process 800 is repeated for each desired key in the plurality of desired keys.

In some examples, the mutation rate of the mutation process 800 is finetuned to yield accurate key-value pairs (or sets), ensuring precise data extraction and a more effective processing experience. In some examples, the mutation rate is tuned in-between iterations of the GA. For example, if the fitness scores of the dataset population 500 are not improving at a desirable rate (or at all), the mutation rate may be increased or decreased until the desired rate of fitness score improvement is achieved. In some examples, the mutation rate is periodically adjusted (e.g., after providing the final dataset 110, daily, weekly, etc.) to improve future performance. In some examples, the convergence rate of the GA during prior sessions is recorded and used to adjust the mutation rate.

As described above, the selection engine 106 is configured to perform p iterations of the GA before providing the final dataset 110. Each iteration (or cycle) of the GA includes performing the selection process 600, the cross-over process 700, and the mutation process 800 in the order described above. After each iteration, the resulting child dataset (i.e., mutated or unmutated) is added to the dataset population 500. For example, after the first iteration, the resulting child dataset replaces the individual dataset with the lowest fitness score in the dataset population of 500, maintaining the number of individuals in the dataset at q. Following subsequent iterations, the resulting child dataset replaces an individual dataset in the dataset population 500. In some examples, the individual dataset with the lowest fitness score is replaced with the child dataset. In the event of a tie, a dataset from the tied datasets may be randomly selected for replacement. In some examples, a dataset may be selected for replacement from the tied datasets based on one or more metrics (e.g., the sum of all key lengths). After the p^{th} iteration of the GA, the selection engine 106 replaces an individual dataset in the dataset population 500 with the resulting child dataset before providing the final dataset 110. In some examples, the selection engine 106 selects the final dataset 110 from the dataset population 500 based on fitness score. For example, the individual dataset with the highest fitness score may be selected as the final dataset 110. In the event of a tie, a dataset from the tied datasets may be selected based on one or more metrics (e.g., the sum of all key lengths). The individual datasets may be identical after the p^{th} iteration due to convergence by the GA. In such examples, any of the individual datasets can be selected as the final dataset 110. In some examples, the final dataset 110 is provided in the key-value format. The final dataset 110 may be presented to the user via the UI of the system 100. In some examples, the final dataset 110 is automatically stored in one or more databases.

As described above, improved systems and methods for extracting tabular data from electronic documents are provided herein. The GA process balances exploration and exploitation through the use of selection, crossover, and mutation operations. The selection process 600 favors individuals with higher fitness scores, promoting the exploitation of promising solutions. The cross-over process 700 combines genetic material from parent individuals, enabling the creation of new solutions that inherit beneficial traits. The mutation process 800 introduces random changes to the individuals, maintaining diversity in the population and promoting exploration of the search space. The GA can handle noisy or incomplete data and still produce meaningful results. The stochastic nature of the GA, with selection, cross-over, and mutation processes, allows it to escape local optima and explore diverse solutions. The GA is robust and can adapt to changing problem conditions or requirements. As the input data complexity grows, the GA process can be adjusted by increasing the population size, the number of iterations, or the computational resources allocated.

### Hardware and Software Implementations

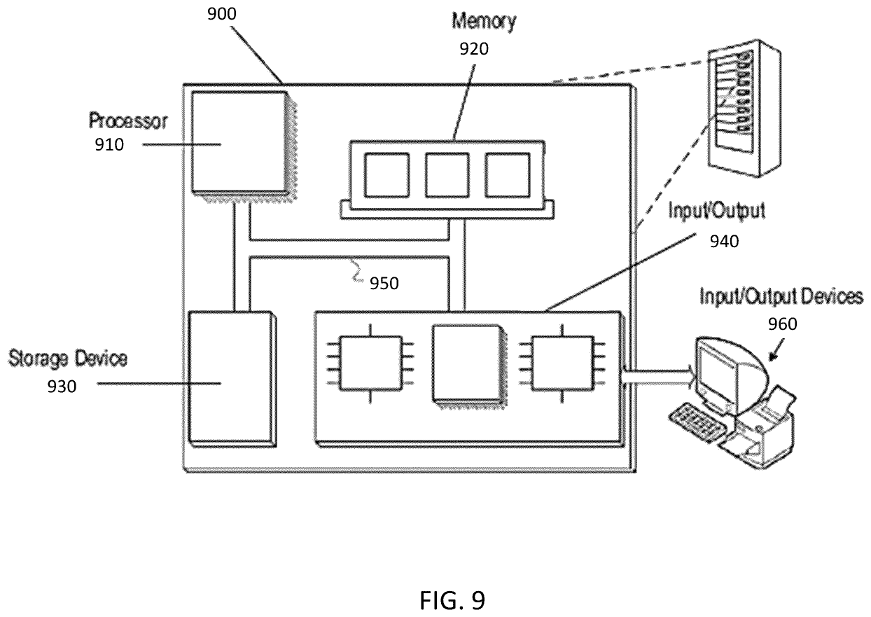

FIG. 9 is a block diagram of an example computer system 900 that may be used in implementing the systems and methods described herein. General-purpose computers, network appliances, mobile devices, or other electronic systems may also include at least portions of the system 900. The system 900 includes a processor 910, a memory 920, a storage device 930, and an input/output device 940. Each of the components 910, 920, 930, and 940 may be interconnected, for example, using a system bus 950. The processor 910 is capable of processing instructions for execution within the system 900. In some implementations, the processor 910 is a single-threaded processor. In some implementations, the processor 910 is a multi-threaded processor. The processor 910 is capable of processing instructions stored in the memory 920 or on the storage device 930.

The memory 920 stores information within the system 900. In some implementations, the memory 920 is a non-transitory computer-readable medium. In some implementations, the memory 920 is a volatile memory unit. In some implementations, the memory 920 is a non-volatile memory unit. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

The storage device 930 is capable of providing mass storage for the system 900. In some implementations, the storage device 930 is a non-transitory computer-readable medium. In various different implementations, the storage device 930 may include, for example, a hard disk device, an optical disk device, a solid-date drive, a flash drive, or some other large capacity storage device. For example, the storage device may store long-term data (e.g., database data, file system data, etc.). The input/output device 940 provides input/output operations for the system 900. In some implementations, the input/output device 940 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 960. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 930 may be implemented in a distributed way over a network, such as a server farm or a set of widely distributed servers, or may be implemented in a single computing device.

Although an example processing system has been described in FIG. 9, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated from the described processes. Accordingly, other implementations are within the scope of the following claims.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for extracting tabular data from an electronic document, comprising:
an extraction engine configured to:
receive an electronic document; and
extract tabular data from the electronic document, wherein the tabular data is extracted using a plurality of data extraction services to provide a plurality of individual datasets;
a population engine configured to generate a dataset population by arranging each individual dataset into a key-value format; and
a selection engine configured to derive a final dataset based on the dataset population using a genetic algorithm.

2. The system of claim 1, wherein the selection engine, when performing the genetic algorithm, performs steps comprising:
selecting a first group of individual datasets from the dataset population;
selecting a second group of individual datasets from the dataset population;
selecting a first parent dataset from the first group of individual datasets;
selecting a second parent dataset from the second group of individual datasets;
combining the first and second parent datasets to produce a child dataset;
selectively mutating the child dataset; and
replacing an individual dataset in the dataset population with the child dataset.

3. The system of claim 2, wherein the selection engine randomly selects the first and second groups of individual datasets from the dataset population.

4. The system of claim 2, wherein the population engine is configured to generate a plurality of desired keys based on the dataset population.

5. The system of claim 4, wherein combining the first and second parent datasets to produce the child dataset comprises:
for each desired key of the plurality of desired keys:
determining whether the first parent dataset includes the desired key;
determining whether the second parent dataset includes the desired key;
in response to a determination that only one of the first and second parent datasets includes the desired key, assigning a corresponding value from the parent dataset having the desired key to a corresponding key in the child dataset; and
in response to a determination that both the first and second parent datasets include the desired key, selecting a corresponding value from the first parent dataset or the second parent dataset based on a predetermined metric, wherein the selected value is assigned to a corresponding key in the child dataset.

6. The system of claim 4, wherein selectively mutating the child dataset comprises:
for each desired key of the plurality of desired keys:
generating a random mutation score;
determining whether to perform a mutation based on the mutation score and a mutation threshold; and
in response to a determination that a mutation should be performed, randomly selecting at least one replacement value for the child dataset from values corresponding to the desired key in the dataset population.

7. The system of claim 4, wherein the selection engine uses a fitness function to assign a fitness score to each individual dataset in the dataset population, the fitness score representing a number of desired keys that are present in the individual dataset.

8. The system of claim 7, wherein the first parent dataset selected by the selection engine has a highest fitness score amongst the first group of individual datasets and the second parent dataset selected by the selection engine has a highest fitness score amongst the second group of individual datasets.

9. The system of claim 7, wherein the individual dataset replaced by the selection engine with the child dataset has a lowest fitness score amongst the dataset population.

10. The system of claim 7, wherein the selection engine is configured to repeat the genetic algorithm until a predetermined number of iterations is reached.

11. The system of claim 10, wherein the selection engine is configured to select the final dataset from the dataset population once the predetermined number of iterations has been reached.

12. The system of claim 11, wherein the final dataset selected by the selection engine has a highest fitness score amongst the dataset population.

13. A method for extracting tabular data from an electronic document, comprising:
receiving, via an extraction engine, an electronic document;
extracting, via the extraction engine, tabular data from the electronic document, wherein the tabular data is extracted using a plurality of data extraction services to provide a plurality of individual datasets;
generating, via a population engine, a dataset population by arranging each individual dataset into a key-value format; and
deriving, via a selection engine, a final dataset based on the dataset population using a genetic algorithm.

14. The method of claim 13, wherein deriving the final dataset using the genetic algorithm comprises:
selecting a first group of individual datasets from the dataset population;
selecting a second group of individual datasets from the dataset population;
selecting a first parent dataset from the first group of individual datasets;
selecting a second parent dataset from the second group of individual datasets;
combining the first and second parent datasets to produce a child dataset;
selectively mutating the child dataset; and
replacing an individual dataset in the dataset population with the child dataset.

15. The method of claim 14, wherein selecting the first and second groups from the dataset population comprises randomly selecting the first and second groups of individual datasets from the dataset population.

16. The method of claim 14, further comprising:
generating, via the population engine, a plurality of desired keys based on the dataset population.

17. The method of claim 16, wherein combining the first and second parent datasets to produce the child dataset comprises:
for each desired key of the plurality of desired keys:
determining whether the first parent dataset includes the desired key;
determining whether the second parent dataset includes the desired key;
in response to a determination that only one of the first and second parent datasets includes the desired key, assigning a corresponding value from the parent dataset having the desired key to a corresponding key in the child dataset; and
in response to a determination that both the first and second parent datasets include the desired key, selecting a corresponding value from the first parent dataset or the second parent dataset based on a predetermined metric, wherein the selected value is assigned to a corresponding key in the child dataset.

18. The method of claim 16, wherein selectively mutating the child dataset comprises:
for each desired key of the plurality of desired keys:
generating a random mutation score;
determining whether to perform a mutation based on the mutation score and a mutation threshold; and
in response to a determination that a mutation should be performed, randomly selecting at least one replacement value for the child dataset from values corresponding to the desired key in the dataset population.

19. The method of claim 16, further comprising:
assigning, via the selection engine, a fitness score to each individual dataset in the dataset population, the fitness score representing a number of desired keys that are present in the individual dataset.

20. The method of claim 19, wherein selecting the first parent dataset from the first group of individual datasets comprises selecting the individual dataset having the highest fitness score amongst the first group of individual datasets, and
wherein selecting the second parent dataset from the second group of individual datasets comprises selecting the individual dataset having the highest fitness score amongst the second group of individual datasets.

21. The method of claim 19, wherein replacing an individual dataset in the dataset population with the child dataset comprises replacing the individual dataset having the lowest fitness score amongst the dataset population with the child dataset.

22. The method of claim 19, wherein deriving the final dataset using the genetic algorithm comprises repeating the genetic algorithm until a predetermined number of iterations is reached.

23. The method of claim 22, wherein the final dataset is selected from the dataset population once the predetermined number of iterations has been reached.

24. The method of claim 23, wherein selecting the final dataset comprises selecting the individual dataset having the highest fitness score amongst the dataset population.
